(19) United States
(12) Patent Application Publication
(10) Pub. No.: US 2002/0000901 A1
(43) Pub. Date: Jan. 3, 2002

(54) Multilayer type printed-wiring board and method of manufacturing multilayer type printed-wiring board

(76) Inventors: Kenji Kuhara, Ishikawa (JP); Akinari Mohri, Ishikawa (JP); Takao Ito, Tokyo (JP); Shoji Horie, Ishikawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/795,445

(22) Filed: Mar. 1, 2001

(30) Foreign Application Priority Data
Mar. 2, 2000 (JP) P2000-061875

(51) Int. Cl. H01P 3/08

(52) U.S. Cl. 333/238; 333/246

(57) ABSTRACT

The impedance of a wiring pattern can be controlled in an easy way. A multilayer type printed-wiring board 1 comprises a pair of inner layer substrates 6, 7, a pair of data transmission wire patterns 4, 5 arranged between the CPU module 2 and the memory modules 3, 3 formed on one of the surfaces of the inner layer substrates 6, 7, said memory modules 3, 3 operating as main memories, and a pair of prepreg layers 10, 11 on the data transmission patterns 4, 5. The insulating layers 6, 7, 10, 11 arranged on the opposite surfaces of the data transmission wire pattern 4, 5 show a variation in the relative dielectric constant not greater than ±4% relative to the value predetermined for the relative dielectric constant at 1 GHz and a variation in the height not greater than ±15% relative to the value predetermined for the height under the condition of 3σ for the standard deviation σ of normal distribution, whereas the data transmission wire patterns 4, 5 show a variation in the width not greater than ±5% relative to the value predetermined for the width and a variation in the height not greater than ±30% relative to the value predetermined for the height under the condition of 3σ for the standard deviation σ of normal distribution.

### BACKGROUND OF THE INVENTION

1. Field of the Invention

This invention relates to a multilayer type printed-wiring board provided with a data transmission wire pattern arranged between a CPU module and a memory module and adapted to high speed data transmission and also to a method of manufacturing such a multilayer type printed-wiring board.

2. Related Background Art

Electronic devices such as game machines for home use and mobile telephone sets typically comprises a printed-wiring board arranged in the cabinet thereof and a CPU (central processing unit) module and a main memory module are mounted there along with other modules. The CPU module and the memory module are connected to each other by a data transmission wire pattern arranged on the printed-wiring board.

Meanwhile, the data transmission wire pattern of a printed-wiring board have to be designed in such a way that the impedance of the wire pattern shows a value that corresponds to the impedance specified for the CPU module and the memory module mounted on the printed-wiring board so that the CPU and the memory may operate reliably on a stable basis.

In order to realize a high speed data transmission between the CPU module and the memory module, a low characteristic impedance has to be selected for the data transmission wire pattern for the purpose of saving power in view of the fact that the data transmission wire pattern shows a high transmission frequency and the selected characteristic impedance of the data transmission wire pattern has to be rigorously controlled so as to make it show the design value.

### BRIEF SUMMARY OF THE INVENTION

In view of the above circumstances, it is therefore an object of the present invention to provide a novel multilayer type printed-wiring board that can easily manage a characteristic impedance of wire pattern, and also a method of manufacturing such a multilayer type printed-wiring board.

Another object of the present invention is to provide a novel multilayer type printed-wiring board, in which the operation of data transmission between the CPU module and the memory module can be conducted on a stable basis by way of a data transmission wire pattern having a rigorously controlled characteristic impedance, and also a method of manufacturing such a multilayer type printed-wiring board.

Still another object of the present invention is to provide a multilayer type printed-wiring board, in which the data transmission wire pattern arranged between the CPU module and the memory module can be made to show a low characteristic impedance level, and also a method of manufacturing such a multilayer type printed-wiring board.

According to the invention, the above objects are achieved by providing a strip line type multilayer printed-wiring board comprising;

an inner layer substrate;

a data transmission wire pattern adapted to data transmission between a CPU module arranged on at least one of the surfaces of said inner layer substrate and a main memory module of said CPU module; and

an insulating substrate arranged on said data transmission wire pattern;

the insulating layers arranged respectively on the opposite surfaces of said data transmission wire pattern having a relative dielectric constant found within ±4% of the predetermined value for the measured frequency of 1 GHz and a height found within ±15% of the predetermined value under the condition of 3σ for the standard deviation σ of normal distribution;

said data transmission wire pattern having a width found within ±5% of the predetermined value and a height found within ±30% of the predetermined value under the condition of 3σ for the standard deviation σ of normal distribution.

With the above arrangement for the data transmission wire pattern of a multilayer type printed-wiring board according to the invention, the characteristic impedance of the data transmission wire pattern can be controlled with ease.

Thus, with a multilayer type printed-wiring board and a method of manufacturing such a multilayer type printed-wiring board according to the invention, as the insulating layers arranged respectively on the opposite surfaces of said data transmission wire pattern are made to have a relative dielectric constant found within ±4% of the predetermined value for the measured frequency of 1 GHz and a height found within ±15% of the predetermined value under the condition of 3σ for the standard deviation σ of normal distribution and the data transmission wire pattern is made to have a width found within ±5% of the predetermined value and a height found within ±30% of the predetermined value under the condition of 3σ for the standard deviation σ of normal distribution, the characteristic impedance of the data transmission wire pattern can be controlled with ease.

### BRIEF DESCRIPTION OF THE SEVERAL VIEWS OF THE DRAWING

FIG. 1 is a schematic plan view of an embodiment of multilayer type printed-wiring board according to the invention, showing a principal part thereof;

FIG. 2 is a schematic cross sectional view of a principal part of the multilayer type printed-wiring board of FIG. 1;

FIG. 3 is a schematic cross sectional view of a principal part of the multilayer type printed-wiring board of FIG. 1, illustrating some of the specified values thereof;

FIG. 4 is a graph illustrating the relationship between the height of the insulating layers and the characteristic impedance of the multilayer type printed-wiring board of FIG. 1;

FIG. 5 is a graph-illustrating the relationship between the relative dielectric constant of the insulating layers and the characteristic impedance of the multilayer type printed-wiring board of FIG. 1;

FIG. 6 is a graph illustrating the relationship between the pattern width and the characteristic impedance of the data transmission wire pattern of the multilayer type printed-wiring board of FIG. 1;

FIG. 7 is a graph illustrating the relationship between the pattern height and the characteristic impedance of the data transmission wire pattern of the multilayer type printed-wiring board of FIG. 1;

FIG. 8 is a histogram of the data transmission wire pattern of the multilayer type printed-wiring board of FIG. 1; and

FIGS. 9A through 9D are schematic partial cross sectional views of the multilayer type printed-wiring board of FIG. 1 in different manufacturing steps.

### DETAILED DESCRIPTION OF THE INVENTION

Now, a multilayer type printed-wiring board and a method of manufacturing such a multilayer type printed-wiring board according to the invention will be described in greater detail by referring to the accompanying drawing that illustrates a preferred embodiment of the invention. The multilayer type printed-wiring board 1 shown in the drawing has a total of six electro-conductive layers and is adapted to be used in a game machine for home use.

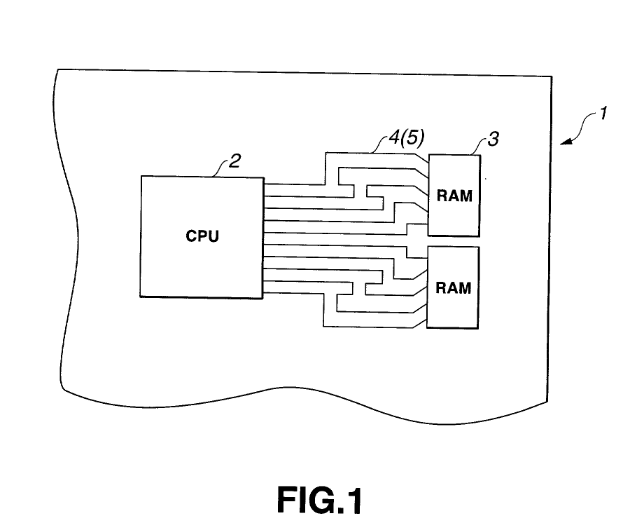

Referring to FIG. 1, the multilayer type printed-wiring board 1 comprises a CPU (central processing unit) module 2 and a pair of memory modules 3, 3 to be used for the CPU module 2 that are arranged on one of the opposite sides of the multilayer type printed-wiring board 1. The CPU module 2 has an operating frequency higher than that of any ordinary CPU and is adapted to operate at a frequency above about 290 MHz or more and typically between 300 MHz and 400 MHz so that it may be able to operate for a high speed image processing operation at a rate of 66 million polygons per second. The memory modules 3, 3 operate as main memory of the CPU module 2, each having a memory capacity of 128 Mbytes. The memory modules 3, 3 are adapted to high speed serial data transmission between the CPU module 2 and themselves and typically comprises so many RDRAMs (Direct Rambus Dynamic Random-access Memories: trademark, available from Rambus Technology).

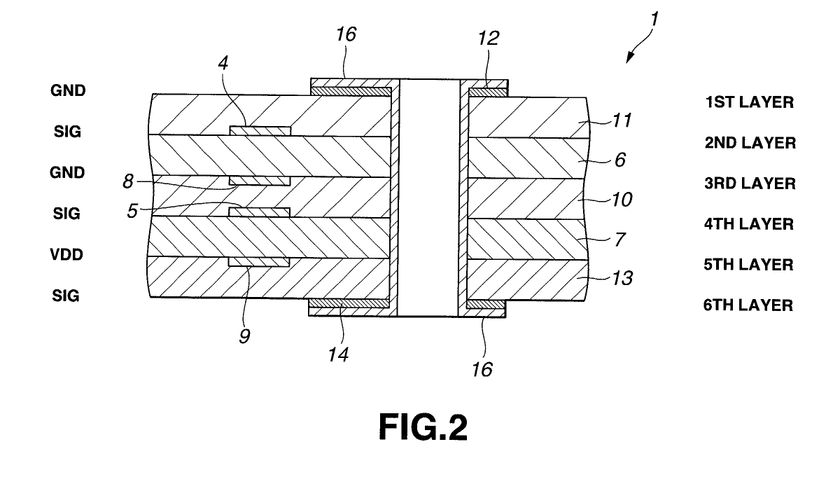

The printed-wiring board 1 carrying the CPU module 2 and the memory modules 3, 3 further comprises data transmission wire patterns 4, 5 operating as data transmission paths between the CPU module 2 and the memory modules 3, 3 and arranged respectively in the inner layers of the second layer and the fourth layer as shown in FIG. 2. The data transmission wire patterns 4, 5 are designed to show a transmission frequency equal to or slightly higher than the operating frequency of the CPU module 2 so that they may effectively operate for high speed data transmissions between the CPU module 2 and the memory modules 3, 3. More specifically, the data transmission wire patterns 4, 5 are designed to show a transmission frequency of about 400 MHz so as to correspond to the operating frequency between 300 MHz and 400 MHz of the CPU module 2.

The data transmission wire patterns 4, 5 are additionally designed to show an impedance with a permissible error range specified for the CPU module 2 and the memory modules 3, 3 so that the CPU module 2 and the memory modules 3, 3 may accurately identify signals. More specifically, the data transmission wire patterns 4, 5 are designed to show a characteristic impedance of 40Ω same as the one specified for the CPU module 2 and the memory modules 3, 3 including the permissible error range.

The layered structure of the above described embodiment of multilayer type printed-wiring board 1 will be discussed below. Referring now to FIG. 2, the multilayer type printed-wiring board 1 comprises first and second inner layer substrates 6, 7. Of these, the inner layer substrate 6 carries on one of the surfaces thereof the data transmission wire pattern 4 of the second layer and on the other surface thereof a wiring pattern 8 that operates as a GND (Ground) layer and forms the third layer. On the other hand, the inner layer substrate 7 carries on one of the surfaces thereof the data transmission wire pattern 5 of the fourth layer and on the other surface thereof a wiring pattern 8 that operates as a power supply layer and forms the fifth layer. Then, the inner layer substrates 6, 7 carrying thereon respectively the wiring pattern 8 of the third layer and the data transmission wire pattern 5 of the fourth layer that are arranged vis-a-vis are pressed and bonded together with a prepreg layer 10 interposed therebetween, said prepreg layer 10 being made of glass fibers impregnated with epoxy resin.

Another wiring pattern 12 that operates as a GND layer and forms the first layer is arranged on the inner layer substrate 6 with another prepreg layer 11 interposed therebetween. Still another wiring pattern 14 that operates as a signal layer and forms the sixth layer is arranged on the inner layer substrate 7 with still another prepreg layer 13 interposed therebetween. The wiring patterns 12 and 14 are electrically connected to each other by boring a through hole 15 through the substrate and arranging a plating layer 16 on the inner wall of the through hole 15. Thus, the multilayer printed-wiring board 1 having the above listed layers shows a strip line structure, in which the data transmission wire pattern 4 is sandwiched by the inner layer substrate 6 that operates as an insulating layer and the prepreg layer 11 and the insulating layer is provided on the opposite surfaces thereof with the respective wiring patterns 8, 12, whereas the data transmission wire pattern 5 is sandwiched by the inner layer substrate 7 that operates as an insulating layer and the prepreg layer 10 and the insulating layer is provided on the opposite surfaces thereof with the respective wiring patterns 8, 9.

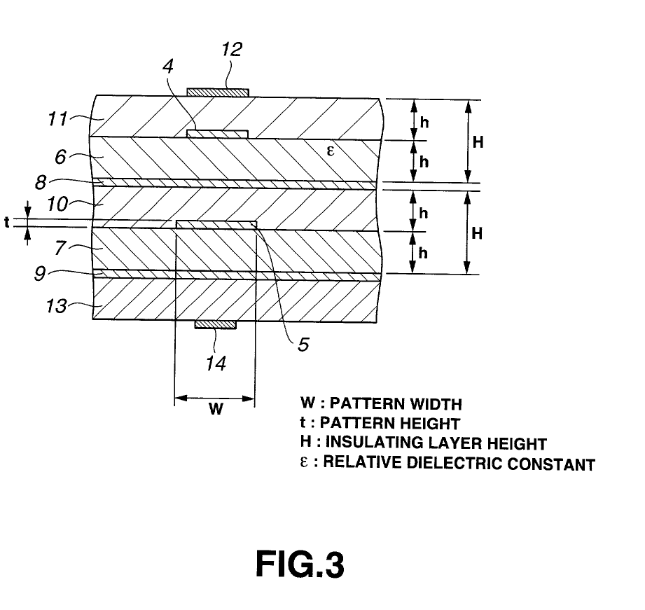

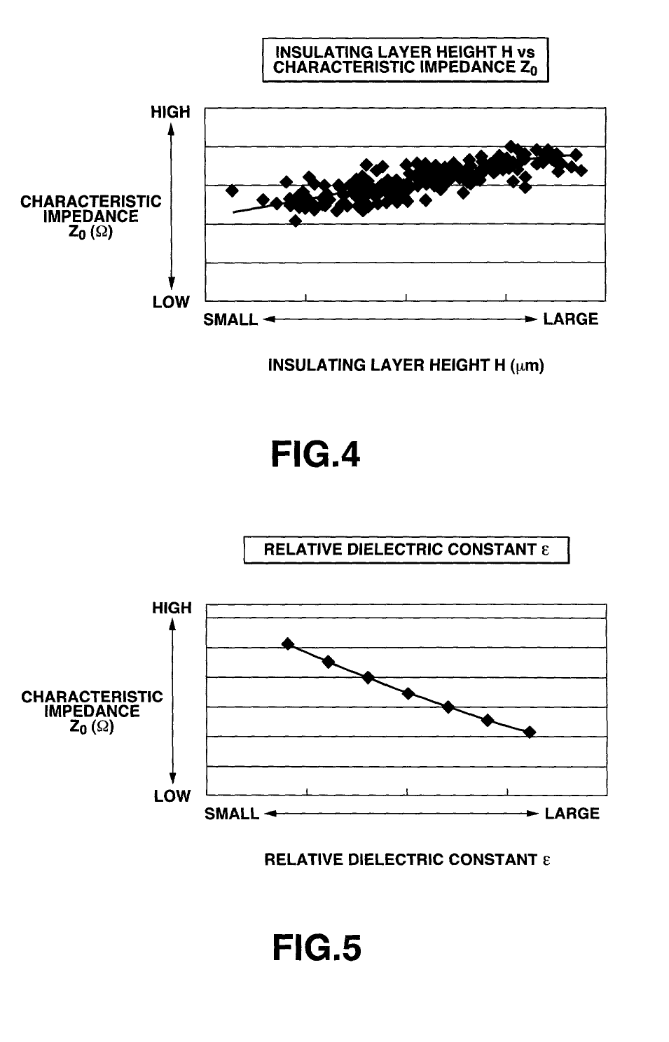

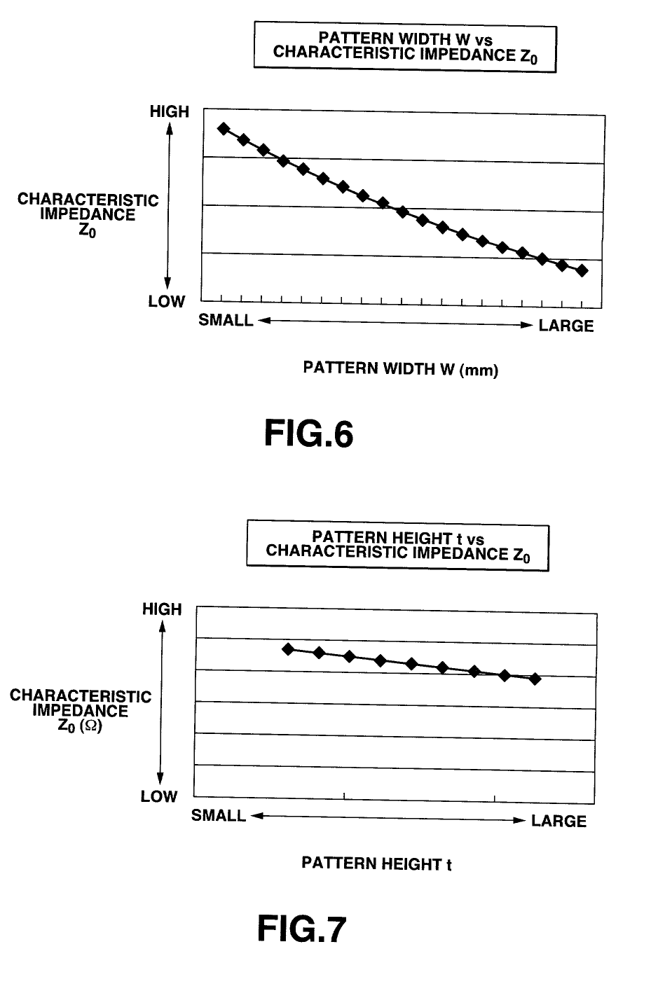

Meanwhile, as pointed out earlier, the data transmission wire patterns 4, 5 of the multilayer type printed-wiring board 1 need to show a low characteristic impedance Z0 that is typically as low as 40Ω. Referring to FIG. 3, the characteristic impedance Z0 of the data transmission wire patterns 4, 5 is defined as a function of the height H of each of the insulating layers formed by the inner layer substrates 6, 7 and the prepreg layers 10, 11 sandwiching respectively the data transmission wire patterns 4, 5, the relative dielectric constant ε of each of the inner layer substrates 6, 7 and the layers 10, 11 of the insulating layers and the width W and the height t of each of the data transmission wire patterns 4, 5. As shown in FIG. 4, the relationship between the characteristic impedance Z0 and the height H of each of the insulating layers containing the data transmission wire patterns 4, 5 therein is such that the characteristic impedance Z0 increases as the height H of each of the insulating layers increases. As seen from FIG. 5, the relationship between the characteristic impedance Z0 and the relative dielectric constant ε of each of the insulating layers is such that the characteristic impedance Z0 decreases as the relative dielectric constant ε increases. Referring to FIG. 6 showing the relationship between the characteristic impedance Z0 and the pattern width W of each of the data transmission wire patterns 4, 5, it will be seen that the characteristic impedance Z0 decreases as the pattern width W increases. Finally, referring to FIG. 7 illustrating the relationship between the characteristic impedance Z0 and the height t of each of the data transmission wire patterns 4, 5, it will be seen that the characteristic impedance Z0 decreases as the pattern height t increases.

Then, on the basis of the above described factors that influence the characteristic impedance Z0 of the wiring patterns, it can be determined by using the approximate expression below:

Z0=30/ε^{½}1n{1+A/2 [A+(A2+6.27)^{½}]}

where A=8(H−t)/π(W+W0), provided that W0=0.1×W.

Thus, if the characteristic impedance Z0 of the data transmission wire patterns 4, 5 is 40Ω, the relative dielectric constant ε of each of the insulating layers formed by the inner layer substrates 6, 7 and the prepreg layers 10, 11 is 4.15 for the measured frequency of 1 GHz. The width W and the height t of each of the data transmission wire patterns 4, 5 are respectively made equal to 0.305 mm and 0.018 mm.

Tables 1 and 2 below show the extent of influence of each of the above listed influencing factors on the characteristic impedance Z0. Note that Table 1 shows the values obtained by using 3σ for the standard deviation σ of normal distribution, whereas Table 2 shows the values obtained by using 4σ for the standard deviation σ of normal distribution.

TABLE 1

| | | | impedance | ratio of variation |
|---|---|---|---|---|
| influencing factor | dispersion | | variation | relative to 40Ω (%) |
| W: pattern width | ±0.015 | mm | ±1.07Ω | ±2.7 |
| ε: relative dielectric | ±0.166 | | ±0.83Ω | ±2.1 |
| constant of insulating | | | | |
| layer | | | | |
| H: height of insulating | ±0.03 | mm | ±1.32Ω | ±3.3 |
| layer | | | | |
| t: height of wiring | ±0.0054 | mm | ±0.54Ω | ±1.4 |
| pattern | | | | |

| | | | |
|---|---|---|---|
| Total (statistic value) | — | ±2.61Ω | ±6.5 |

*Variations are determined by using 3σ.

TABLE 2

| | | | impedance | ratio of variation |
|---|---|---|---|---|
| influencing factor | dispersion | | variation | relative to 40Ω (%) |
| W: pattern width | ±0.020 | mm | ±1.43Ω | ±3.6 |
| ε: relative dielectric | ±0.221 | | ±1.11Ω | ±2.8 |
| constant of insulating | | | | |
| layer | | | | |
| H: height of insulating | ±0.04 | mm | ±1.76Ω | ±4.4 |
| layer | | | | |
| t: height of wiring | ±0.0072 | mm | ±0.72Ω | ±1.8 |
| pattern | | | | |

| | | | |
|---|---|---|---|
| Total (statistic value) | — | ±3.49Ω | ±8.7 |

*Variations are determined by using 4σ.

The value of TOTAL variation in each of Tables 1 and 2 is determined by using [Formula 1] below.

$$TOTALvariation = \frac{variation ϵ}{material factor} \sqrt{\frac{( {VariationW}^{2} + {VariationH}^{2} + {variationt}^{2} )}{process factor}} \qquad \text{[Formula 1]}$$

From Table 1 above, it will be seen that the degrees of influence of the influencing factors are such that height H of insulating layer>pattern width W of data transmission wire patterns 4, 5>relative dielectric constant ε of insulating layers>height t of data transmission wire patterns, 4, 5. On the other hand, as for the characteristic impedance Z0 of the data transmission wire patterns 4, 5, its variation has to be less than 10% of the predetermined value as defined on the basis of the specified values of the CPU module 2 and the memory modules 3, 3. On other words, the characteristic impedance Z0 is required to be 40±4Ω. Table 3 below shows the permissible errors of the influencing factors.

TABLE 3

| influencing factor | predetermined value | error | error | |
|---|---|---|---|---|
| W: pattern width | 0.305 mm | ±5% | ±0.015 | mm |
| ε: relative dielectric | 4.15 | ±4% | ±0.166 | |
| constant of insulating | | | | |
| layer | | | | |
| H: height of insulating | h: 0.2 mm (inner | ±15% | ±0.03 | mm |
| layer | layer substrates 6, 7, | | | |
| | prepreg 10, 11, 13) | | | |
| t: height of wiring | 0.018 mm | ±30% | ±0.0054 | mm |
| pattern | | | | |

*Variations are determined by using 3σ.

Then, the variation of the characteristic impedance Z0 can beheld to less than 10% of the predetermined value and hence the characteristic impedance Z0 can meet the requirement of 40±4Ω when the influencing factors satisfy the respective requirements of Table 1 under the condition of 3σ for the standard deviation σ of normal distribution.

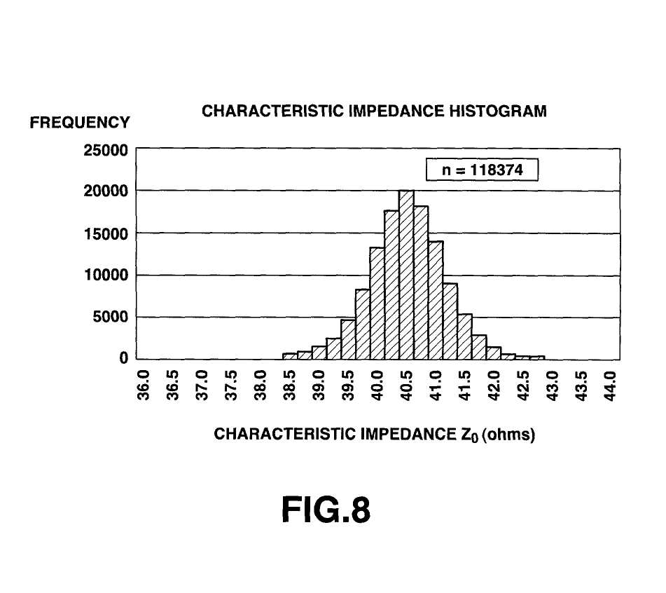

More specifically, as shown in FIG. 8, the variation of the characteristic impedance Z0 of each of the data transmission wire patterns 4, 5 can be held to less than ±10% of the predetermined value when the variation of the relative dielectric constant ε of each of the insulating layers formed by the inner layer substrates 6, 7 and the prepreg layers 10, 11 is held to less than ±4% of the value predetermined for it under the condition of 3σ for the standard deviation σ of normal distribution and the variation of the height H of each of the insulating layers is held to less than ±5% of the value predetermined for it, while the variation of the width W of each of the data transmission wire patterns 4, 5 is held to less than ±5% of the value predetermined for it and the variation of the height t of each of the data transmission wire patterns 4, 5 is held to less than ±10% of the value predetermined for it. In specific terms, the characteristic impedance Z0 of each of the data transmission patterns 4, 5 can be made to satisfy the requirement of 40±4Ω when the variation of the relative dielectric constant ε of each of the insulating layers formed by the inner layer substrates 6, 7 and the prepreg layers 10, 11 is held to less than ±0.166 for the value of 4.15 defined for the relative dielectric constant under the condition of 1 GHz of the measured frequency and the variation of the height H of each of the insulating layers is held to less than ±0.03 mm for 0.2 mm defined for the height, while the variation of the width W of each of the data transmission wire patterns 4, 5 is held to less than ±0.015 mm for 0.305 mm defined for the width and the variation of the height of each of the data transmission wire patterns 4,5 is held to less than ±0.0018 mm for 0.018 mm defined for the height.

As pointed out earlier, the degrees of influence of the influencing factors on the characteristic impedance Z0 are such that height H of insulating layer>pattern width W of data transmission wire patterns 4, 5>relative dielectric constant ε of insulating layers>height t of data transmission wire patterns, 4, 5. Therefore, it is advisable to determine firstly the height and the relative dielectric constant of each of the insulating layers that are material factors, taking the level of manufacturing cost into consideration and then the width and the height of each of the data transmission wire patterns 4, 5 that are process factors and influenced by the etching process. Since the height of each of the data transmission wire patterns 4, 5 exerts little influence on the characteristic impedance Z0 as seen from Tables 1 and 2, it may have a greater tolerance than the width.

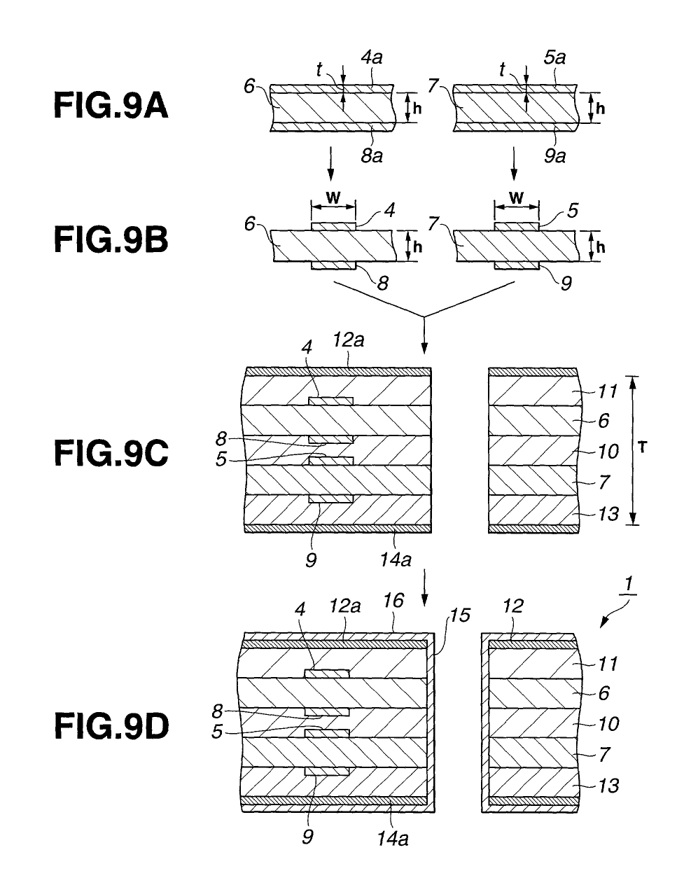

A multilayer type printed-wiring board 1 according to the invention and having the above described configuration is manufactured in a manner as illustrated in FIGS. 9A through 9D. Firstly, referring to FIG. 9A, copper foils 4a, 8a, 5a, 9a are formed as electro-conductive layers to a thickness of 0.018±0.0018 mm each on the opposite surfaces inner layer substrates 6, 7, each having a height H of 0.2±0.02 mm and a relative dielectric constant ε of 4.15 (1 GHz) ±0.166. The copper foil 4a is used to form the data transmission wire pattern 4 of the second layer and the copper foil 8a is used to form the wiring pattern 8 operating as the GND layer of the third layer, whereas the copper foil 5a is used to form the data transmission wire pattern 5 of the fourth layer and the copper foil 9a is used to form the wiring pattern 9 operating as the power supply layer of the fifth layer. Subsequently, a dry film is bonded to each of the copper foils 4a, 8a, 5a, 9a and then subjected to an exposure/development process and subsequently to an etching process. As a result, the data transmission wire pattern 4 is formed on one of the surfaces of the inner layer substrate 6 and the wiring pattern 8 operating as the GND layer is formed on the other surface of the inner layer substrate 6, while, similarly, the data transmission wire pattern 5 is formed on one of the surfaces of the inner layer substrate 7 and the wiring pattern 9 operating as the power supply layer is formed on the other surface of the inner layer substrate 7 as shown in FIG. 9B.

The data transmission wire patterns 4, 5 can be made to show a pattern width W of 0.305±0.015 mm when a high precision photo tool is used in the exposure/development process for forming the data transmission wire patterns 4, 5 and the moving speed of the etching conveyor is regulated so as to make the average pattern width W of the data transmission wire patterns 4, 5 equal to 0.302 to 0.308 mm with a variation less than ½ of comparable conventional patterns in a sampling test.

Then, as shown in FIG. 9C, the inner layer substrate 6 formed by patterning the copper foils 4a, 8a and the inner layer substrate 7 formed by patterning the copper foils 5a, 9a are subjected to a press molding process with the prepreg layer 11 that makes an outer layer substrate carrying a copper foil 12a bonded thereto and operating as the first layer and the prepreg layer 13 that makes another outer layer substrate carrying a copper foil 14a bonded thereto and operating as the sixth layer. As a result, they become integral components of the multilayer type printed-wiring board 1. The prepreg layers 10, 11, 13 have a nominal height of 0.2 mm. Additionally, by the press process, the overall height T of the insulating layers including the inner layer substrates 6, 7 and the prepreg layers 10, 11, 13 is made to show a variation of less than ±0.06 mm, or ±15%, relative to the predetermined value of the height.

Then, the through hole 15 is bored through the multilayer type printed-wiring board by means of a drill in order to electrically connect the copper foil 12a of the electro-conductive layer of the first layer and the copper foil 14a of the electro-conductive layer of the sixth layer. Then, a plating layer 16 is formed on the entire surfaces of the copper foils 12a and 14a including the inner wall of the through hole 15 typically by means of an electrolytic or non-electrolytic plating method to electrically connect the copper foils 12a and 14a. Subsequently, a dry film is bonded to the surface of each of the copper foils 12a and 14a and subjected to an exposure/development process and then to an etching process. As a result, a wiring pattern 12 operating as a GND layer is formed on the prepreg layer 11 while a wiring pattern 14 operating as a signal layer is formed on the prepreg layer 14 as shown in FIG. 2.

As described above in detail, with a multilayer type printed-wiring board 1 according to the invention, the variation of the characteristic impedance Z0 of each of the data transmission wire patterns 4, 5 can be held to less than ±10% of the predetermined value so that the characteristic impedance Z0 can be controlled with ease when the variation of the relative dielectric constant ε of each of the insulating layers formed by the inner layer substrates 6, 7 and the prepreg layers 10, 11 is held to less than ±4% of the value predetermined for it under the condition of 3σ for the standard deviation σ of normal distribution and the variation of the height H of each of the insulating layers is held to less than ±15% of the value predetermined for it, while the variation of the width W of each of the data transmission wire patterns 4, 5 is held to less than ±5% of the value predetermined for it and the variation of the height t of each of the data transmission wire patterns 4, 5 is held to less than ±10% of the value predetermined for it.

In specific terms, the characteristic impedance Z0 of each of the data transmission patterns 4, 5 can be made to satisfy the requirement of 40±4Ω when the variation of the relative dielectric constant ε of each of the insulating layers formed by the inner layer substrates 6, 7 and the prepreg layers 10, 11 is held to less than ±0.166 for the value of 4.15 defined for the relative dielectric constant under the condition of 1 GHz of the measured frequency and the variation of the height H of each of the insulating layers is held to less than ±0.03 mm for 0.2 mm defined for the height, while the variation of the width W of each of the data transmission wire patterns 4, 5 is held to less than ±0.015 mm for 0.305 mm defined for the width and the variation of the height of each of the data transmission wire patterns 4, 5 is held to less than ±0.0054 mm for 0.018 mm defined for the height. Therefore, with the multilayer type printed-wiring board 1, the transmission frequency of the data transmission wire patterns 4, 5 of the CPU module 2 and the memory module 3 can be raised to a level equal to or higher than that of the operating frequency of the CPU module 2 which is not less than about 290 MHz or typically to a transmission frequency level of about 400 MHz to realize high speed data transmissions between the CPU module 2 and the memory module 3 as well as a low characteristic impedance Z0 for power saving.

What is claimed is:

1. A strip line type multilayer printed-wiring board comprising;
an inner layer substrate;
a data transmission wire pattern adapted to data transmission between a CPU module arranged on at least one of the surfaces of said inner layer substrate and a main memory module of said CPU module; and
an insulating substrate arranged on said data transmission wire pattern;
the insulating layers arranged respectively on the opposite surfaces of said data transmission wire pattern having a relative dielectric constant found within ±4% of the predetermined value for the measured frequency of 1 GHz and a height found within ±15% of the predetermined value under the condition of 3σ for the standard deviation σ of normal distribution;
said data transmission wire pattern having a width found within ±5% of the predetermined value and a height found within ±30% of the predetermined value under the condition of 3σ for the standard deviation σ of normal distribution.

2. The multilayer type printed-wiring board according to claim 1, wherein said inner layer substrate and said insulating substrate show a relative dielectric constant of 4.15±0.166 or less and a height of 0.2±0.03 mm or less; and
said data transmission wire pattern has a width of 0.305±0.015 mm or less and a height of 0.018±0.0054 mm or less.

3. The multilayer type printed-wiring board according to claim 1, wherein the characteristic impedance of said data transmission wire pattern is found within ±10% of the predetermined value for the characteristic impedance.

4. The multilayer type printed-wiring board according to claim 2, wherein the characteristic impedance of said data transmission wire pattern is 40±4Ω or less.

5. The multilayer type printed-wiring board according to claim 1, wherein the transmission frequency of said data transmission wire pattern is equal to or higher than the operating frequency of said CPU module.

6. The multilayer type printed-wiring board according to claim 1, wherein the operating frequency of said CPU module is 290 MHz or more.

7. The multilayer type printed-wiring board according to claim 1, wherein the transmission frequency of said data transmission wire pattern is about 400 MHz.

8. A method of manufacturing a strip line type multilayer printed-wiring board comprising;
an inner layer substrate;
a data transmission wire pattern adapted to data transmission between a CPU module arranged on at least one of the surfaces of said inner layer substrate and a main memory module of said CPU module;
an insulating substrate arranged on said data transmission wire pattern;
said method being adapted to make the insulating layers arranged respectively on the opposite surfaces of said data transmission wire pattern show a relative dielectric constant found within ±4% of the predetermined value for the measured frequency of 1 GHz and a height found within ±15% of the predetermined value under the condition of 3σ for the standard deviation σ of normal distribution; and
said data transmission wire pattern show a width found within ±5% of the predetermined value and a height found within ±30% of the predetermined value under the condition of 3σ for the standard deviation σ of normal distribution.

9. The method of manufacturing a multilayer type printed-wiring board according to claim 8, wherein the moving speed of the conveyor is regulated so as to make the average pattern width equal to a predetermined value in a sampling test conducted in the pattern etching process.

10. The method of manufacturing a multilayer type printed-wiring board according to claim 8, wherein said inner layer substrate and said insulating substrate show a relative dielectric constant of 4.15±0.166 or less and a height of 0.2±0.03 mm or less; and
said data transmission wire pattern has a width of 0.305±0.015 mm or less and a height of 0.018±0.0054 mm or less.

11. The method of manufacturing a multilayer type printed-wiring board according to claim 8, wherein the characteristic impedance of said data transmission wire pattern is found within ±10% of the predetermined value for the characteristic impedance.

12. The method of manufacturing a multilayer type printed-wiring board according to claim 10, wherein the characteristic impedance of said data transmission wire pattern is 40±4Ω or less.

13. The method of manufacturing a multilayer type printed-wiring board according to claim 8, wherein the transmission frequency of said data transmission wire pattern is equal to or higher than the operating frequency of said CPU module.

14. The method of manufacturing a multilayer type printed-wiring board according to claim 8, wherein the operating frequency of said CPU module is 290 MHz or more.

15. The method of manufacturing a multilayer type printed-wiring board according to claim 8, wherein the transmission frequency of said data transmission wire pattern is about 400 MHz.
